(19) United States
(12) Patent Application Publication
(10) Pub. No.: US 2011/0213985 A1
(43) Pub. Date: Sep. 1, 2011

(54) TWO FACTOR AUTHENTICATION SCHEME

(75) Inventor: David C. Miller, Grand Blanc, MI (US)

(73) Assignee: Compuware Corporation, Detroit, MI (US)

(21) Appl. No.: 12/713,246

(22) Filed: Feb. 26, 2010

(51) Int. Cl. H04L 9/32; G06F 21/00

(52) U.S. Cl. 713/185; 726/9; 713/182

(57) ABSTRACT

An improved method is provided for generating an authentication factor for authenticating a user. The method includes: assigning a unique identifier to a user of the computing resource; determining a value for a challenge to the user, where the value is determined by a random determination method; concatenating the identifier with the value to form an input string; encrypting the input string using a one-way hash function to yield an output string of characters; and selecting a subset of characters from the output string to serve as the authentication factor for the user. This improved method may be used to generate grids used in a grid authentication scheme.

### FIELD

The present disclosure relates to an improved method for generating an authentication factor for authenticating access to a computing resource.

### BACKGROUND

Two-factor authentication is a security process in which the user provides two different means of identification (i.e., authentication factors). Authentication factors are typically classified into one of three types. Ownership factors are something a user has, such as identification card or security token. Knowledge factors are something a user knows, such as a password. Inherency factors are something a user is, such as a fingerprint.

Grid authentication has recently emerged as a two-factor authentication technique. Grid authentication uses a wallet-size card that contains a grid of randomly generated values. This card is commonly referred to as a bingo card. In a typical implementation, a user seeking authentication is first prompted for their user identification and password which serves as a first authentication factor. The user is then prompted to input a value from a randomly selected cell in the grid. The user is authenticated if they enter the correct value from the grid. The grid challenge serves as a second authentication factor.

Grid authentication is easy to produce, easy to replace and relatively inexpensive. However, this technique has drawbacks. Depending on the size of the grid, the number of distinct authentication factors is limited and therefore susceptible to being spoofed. Therefore, it is desirable to improve upon conventional grid authentication. In particular, it is desirable to develop an improved method for generating authentication factors that can be used in grid authentication as well as other authentication schemes.

This section provides background information related to the present disclosure which is not necessarily prior art.

### SUMMARY

An improved method is provided for generating an authentication factor for authenticating a user. The method includes: assigning a unique identifier to a user of the computing resource; determining a value for a challenge to the user, where the value is determined by a random determination method; concatenating the identifier with the value to form an input string; encrypting the input string using a one-way hash function to yield an output string of characters; and selecting a subset of characters from the output string to serve as the authentication factor for the user. This improved method may be used to generate grids used in a grid authentication scheme.

In another implementation, a software application incorporating the improved method is downloaded to a user's computing device and operates to generate the authentication factor used in the authentication scheme.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a flowchart illustrating an improved method for generating an authentication factor;

FIG. 2 illustrates an exemplary grid used in a grid authentication scheme;

FIG. 3 is a diagram depicting a two factor grid authentication scheme; and

FIG. 4 is a diagram depicting another two factor authentication scheme.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

FIG. 1 provides an overview of an improved method 10 for generating an authentication factor which may be used to authenticate a user. Steps for generating the authentication factor are further described below. It is to be understood that only the relevant steps of the methodology are discussed in relation to FIG. 1, but that other software-implemented instructions may be needed to control and manage the overall authentication process.

First, a unique identifier or key is assigned 12 to each user requiring authentication. The key is preferably generated randomly using techniques readily known. In an exemplary embodiment, the key may be 80 bits or 128 bits long. Other key sizes are also contemplated by this disclosure.

During the authentication process, a user is presented at 14 with a challenge. For example, the user may be prompted for a value from a cell in a grid possessed by the user. An important aspect of this disclosure is that the user is prompted with a value determined by a random determination method. In the case of the grid, the cell is selected randomly. In other words, the challenge is changing each time the user seeks authentication. Other types of challenges will be further described below. In any case, the response to the user challenge provides a basis for generating the authentication factor.

To generate an authentication factor, the unique identifier is concatenated at 16 with the value from the user challenge to form an input string. The input string is then encrypted at 18 using a cipher to yield an output string of characters. In an exemplary embodiment, the cipher is a hash function such as SHA-256. Other types of ciphers also fall within the scope of this disclosure. The output string (or a subset of characters thereof) serves as the authentication factor as indicated at 19. In this way, the key as well as the value from the user challenge are kept secret during any transmission of the authentication factor between the user and an authenticator.

The authentication factor is then used to authenticate the user. Authentication is generally the process of determining whether someone or something is who or what they claim to be. One common use of authentication is access control. For example, granting a user access to a computing resource once the user has been authenticated by an authentication process. In another example, a lock may be unlocked once the user has been authenticated. While it is readily understood that authentication is a process distinct from access control, the description provided herein links authentication with access control. Authentication may be performed independent from any other process or may be linked with some other process.

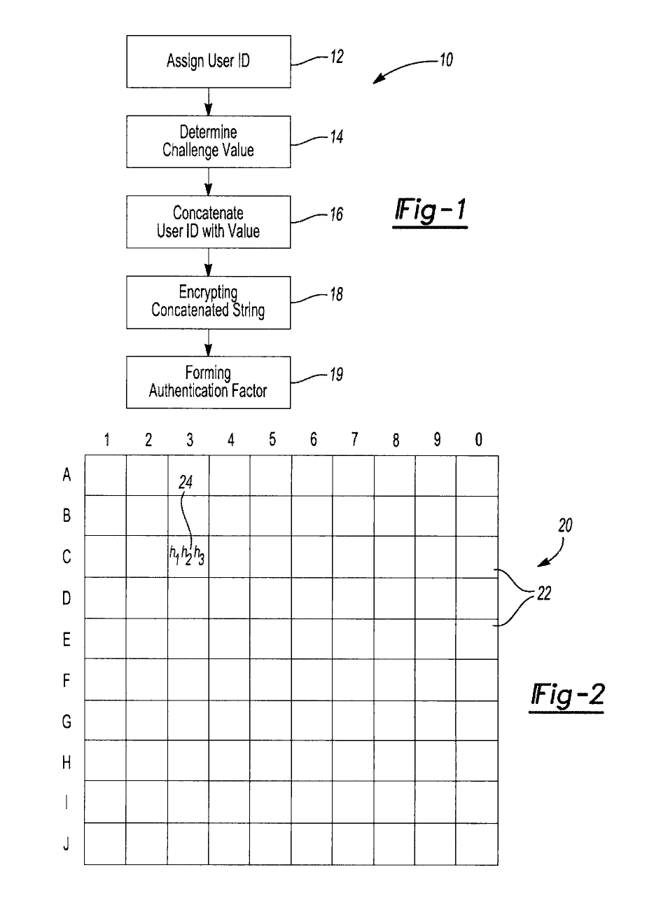

This improved method for generating an authentication factor may be integrated into a grid authentication scheme as further described below. Grid authentication uses a grid in possession of a user to authenticate the user. FIG. 2 illustrates an exemplary grid 20. The grid is comprised of a plurality of cells 22 or spatial positions. Each cell has an identifier for its position in the grid. For example, the cell labeled 24 is identified as C3 as shown in FIG. 2. In other words, the identifier is expressed in a row and column format. This enables the method to support grids of varying size, although 10×10 is the currently preferred size. Other identification schemes for the grid positions are envisioned by this disclosure.

Values in the grid must be generated in a manner that is unique to each user. Thus, a key is first assigned to each of the users. When generating the values in the grid, the values are derived in part from the key assigned to the user. In addition, a given value in the grid is derived in part from the identifier for the corresponding cell in the grid. More specifically, the key is concatenated with the identifier for a given cell in the grid to form an input string. The input string for an eight (8) digit key at the cell labeled “C3” is represented as follows:

Input string=k₁k₂k₃k₄k₅k₆k₇k₈+C3;

whereas, the input string for the same key at the cell labeled “B1” is represented as:

Input string=k₁k₂k₃k₄k₅k₆k₇k₈+B1.

In this way, the input string is unique to user assigned the key as well as to the corresponding location in the grid.

Next, the input string is encrypted using a cipher to yield an output string of characters. For example, a hash value is computed by applying a one-way hash function to the input string. The hash value can serve as the value assigned to corresponding location in the grid and may be represented as:

Output string=h₈h₇h₆h₅h₄h₃h₂h₁

Alternatively, only a subset of characters in the hash value is preferably used as the value assigned to the grid, thereby reducing likely success of spoof attacks and minimizing size of the grid. In an exemplary embodiment, the four least significant bits of the hash value (i.e., h₄h₃h₂h₁) are selected as the value assigned to the grid although other subsets of characters taken from the hash value may also be used. Thus, the string of bits used as the grid value may be of any length. To complete the grid, this process is repeated for each cell in the grid using the corresponding identifier for the cell position to generate the value for the cell. This method for creating the grid significantly increases the entropy of the values in the grid.

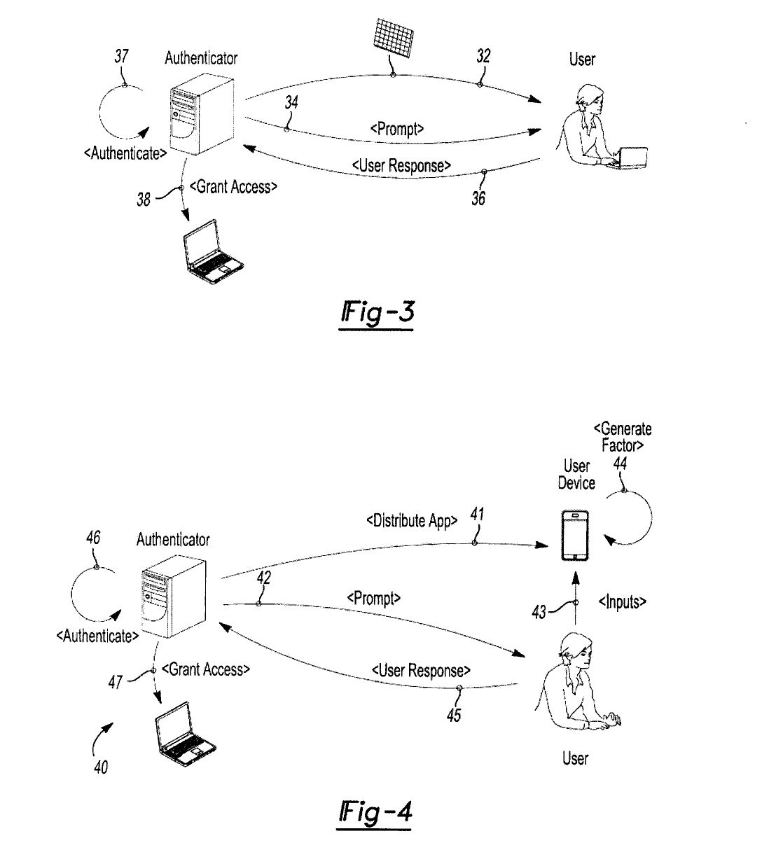

A two factor authentication scheme 30 using such a grid is further described in relation to FIG. 3. Prior to seeking authentication, a grid is distributed at 32 to a user from an authenticating computing device. The grid is unique to the user and may be generated in the manner described above.

In one exemplary embodiment, the grid is sent electronically to a computing device associated with the user. For example, the grid may be emailed in a PDF format to a registered email address for the user. The user can in turn view and/or save the grid on any computing device that is configured to render a PDF file format. Alternatively, the user may elect to print a copy of the grid which may be carried and referenced by the user.

In another embodiment, a physical embodiment of the grid is distributed directly to the user. To do so, the authenticator may contract with a third party to print a batch of cards with pre-populated grids. Each card will have a serial number. Cards can be mailed or otherwise delivered to the users. When a user receives a card, they will bind the card to their unique identifier by providing the serial number from the card via an interface to the authenticator. Alternatively, the authenticator could bind the user to the card at the time the card is issued to the user.

After receiving a grid, the user may seek authentication by interfacing with a computing device. The authentication procedure is preferably implemented by an authenticating computing device (also referred to herein as the authenticator) using computer-executable instructions executed by a microprocessor and stored in a memory device associated with the computing device. The user may interface directly with the computing device implementing the authentication procedure or with a computing device serving an intermediary between the user and the authenticating computing device. Other implementations for the authentication procedure are also contemplated by this disclosure.

When seeking authentication, the user is first prompted to provide a valid user identifier and corresponding password to the authenticating computing device. The user in turn inputs their user identifier and corresponding password to the authenticating computing device. When the user identifier and password match the corresponding values known to the authenticator, the authenticating procedure advances to the next stage. In this exemplary embodiment, the password serves as a first authentication factor in a two factor authentication scheme. It is readily understood that other types of authentication factors (e.g., fingerprints) may be used in place of the password.

Next, the user is prompted at 34 for a value in the grid associated with the user. In one exemplary embodiment, the grid for each user is generated and stored concurrently with the initial distribution of the grid to the user. The grid may be stored in a data store (i.e., memory device) associated with the authenticating computing device. A spatial position in the grid is randomly selected and the value corresponding to the selected spatial position is retrieved from the stored grid. Spatial positions are preferably selected in a random manner such that each position is selected once before any position is selected twice. The user is then prompted for the value at the selected spatial position of the grid (e.g., please input the value at C3 of the grid).

In an alternative embodiment, the grid is not stored by the authenticating computing device. Rather, only the user identifier is stored by the authenticating computing device. To prompt a user, a spatial position in the grid is randomly selected by a random selection method and the user is prompted for the value at the selected spatial position of the grid. The authenticating computing device then generates the value corresponding to the selected spatial position (i.e., substantially concurrent with prompting of the user). By storing only the user identifier and not the entire grid for each user, this approach significantly reduces the storage requirements.

Upon being prompted, the user references the grid in their possession and provides at 36 the requested value from the grid to the authenticator. The authenticator in turn receives the requested value from the user in response to the prompt. When the input from the user matches the value corresponding to the selected position in the grid, the user is authenticated at 37 and the authenticator may proceed to grant the user access to some computing resource as indicated at 38.

FIG. 4 depicts another authentication scheme 40 that incorporates the improved method for generating an authentication factor described above. In this approach, the grid is replaced with a software application that operates to compute an authentication factor for a user. The software application is distributed at 41 by an authenticator to a computing device associated with the user. For example, the software application may be downloaded by the user over a secure communication link to the user's computing device. Various secure methods are known for distributing software applications to a user's computing device.

The authentication factor for a user is generated in a manner that is unique to each user. To do so, a unique identifier or key is assigned to each user requiring authentication. The keys are stored in a data store accessible by the authenticating computing device. In addition, the downloaded software application is configured with the key that has been assigned to the user. The key is preferably maintained on the user's computing device in a manner that makes the key inaccessible by the user. Various such techniques are known. The software program also operates to compute an authentication factor using the algorithm set forth herein. In an exemplary embodiment, the software program may be implemented using the Java development platform.

When seeking authentication, the user first interfaces at 42 with the authenticating computing device. The authenticating computing device provides the user with a string of characters that is to be input to the software application. The string is generated randomly using any suitable random number generator. Since the number of characters in the string is not bound, this scheme can greatly increase the entropy of the system. For example, an input string having 7-10 characters increases the number of permutations to well over one trillion. In the case of a two factor authentication scheme, the user may first be prompted for a valid user identifier and corresponding password before being presented with challenge string.

Given the challenge string, the user inputs the string at 43 into an interface supported by the software application running on the user's computing device. The software program receives the challenge string from the user and generates 44 an authentication factor for the user based in part on the challenge string input into the software application by the user. More specifically, the user key embedded in the software application is concatenated with the challenge string to form an input string. The input string is encrypted using a cipher which yields an output string of characters. The output string (or a subset of characters therein) serve as the authentication factor for the user.

The authentication factor is communicated 45 from the user to the authenticating device for authentication. In one embodiment, the authentication factor is displayed to the user via a display on the user's computing device. The user in turn inputs the authentication factor directly into an interface associated with the authenticating computing device. In another embodiment, the software application is operable to transmit the authentication factor from the user's computing device via a communication link to the authenticating computing device. In either case, the authentication factor is received by the authenticating computing device.

Likewise, the authenticating computing device generates an authentication factor for the user based in part on the challenge string. The user's key is accessible to the authenticating computing device as noted above. Once the challenge string has been generated, the authenticating computing device can then generate the corresponding authentication factor for the user using the same algorithm as deployed on the user's computing device. In other words, the user's key is concatenated with the challenge string to form an input string which is encrypted using a cipher, where the output string (or a subset of characters therein) serves as the authentication factor for the user. Generation of the authentication factor occurs substantially concurrent with or subsequent to the creation of the challenge string.

The user is authenticated 46 by the authenticator when the authentication factor received from the user matches the authentication factor generated by the authenticator. Once again, the authenticator may proceed to grant the user access to a computing resource or initiate some other process when the user is successfully authenticated. Conversely, authentication of the user fails if the authentication factors do not precisely match.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method for generating an authentication factor for authenticating access to a computing resource; comprising:
assigning a unique identifier to a user of the computing resource;
determining a value for a challenge to the user, where the value is determined by a random determination method;
concatenating the identifier with the value to form an input string;
encrypting the input string using a one-way hash function to yield an output string of characters;
selecting a subset of characters from the output string to serve as the authentication factor for the user; and
granting the user access to the computing resource upon receipt of the authentication factor from user.

2. The method of claim 1 further comprises:
distributing a grid to the user from an authenticator, the grid having values assigned to each spatial position thereof and serving as authentication factors for the user;
prompting the user for a value at a particular spatial position in the grid; and
granting user access to the computing resource upon receipt by the authenticator of the value corresponding to the particular spatial position in the grid.

3. The method of claim 2 wherein prompting the user further comprises:
storing the user identifier in a data store associated with the authenticator;
randomly selecting a spatial position in the grid; and
generating a value corresponding to the selected spatial position substantially concurrent with prompting the user.

4. The method of claim 2 further comprises generating the grid by
(a) concatenating the user identifier with an identifier for a given spatial position in the grid to form an input string;
(b) computing a hash value by applying a hash function to the input string;
(c) selecting a subset of characters which comprise the hash value to serve as a given value for the grid corresponding to the spatial position used to derived the given value; and
repeating steps (a)-(c) for each spatial position in the grid.

5. The method of claim 1 further comprises:
distributing a software application from an authenticator to a computing device distinct from the authenticator and associated with the user, wherein the software application is configured with the unique identifier assigned to the user;
determining by the authenticator a value for generating an authentication factor using a random determination method;
prompting the user to input the value into the software application;
generating an authentication factor for the user based in part on the value input into the software application by the user; and
authenticating the user upon receipt of the authentication factor by the authenticator.

6. The method of claim 5 wherein determining a value further comprises randomly generating the value using a random number generator.

7. The method of claim 5 wherein prompting the user further comprises transmitting the value from the authenticator via a communication link to the software application residing on the computing device.

8. The method of claim 5 wherein generating an authentication factor further comprises:
concatenating the user identifier with the value input by the user into the software application to form an input string;
computing a hash value by applying a hash function to the input string; and
selecting a subset of characters from the hash value to serve as the authentication factor.

9. The method of claim 5 further comprises computing the authentication factor using a processor on the computing device and transmitting the authentication factor from the computing device via a communication link to the authenticator.

10. A method for authenticating a user to access a computing resource, comprising:
generating a grid having spatial positions and values assigned to each spatial position, where values in the grid are derived in part from an identifier for its spatial position in grid;
distributing the grid from an authenticator to the user;
prompting the user for a value at a particular spatial position of the grid;
receiving by the authenticator an input from the user in response to the prompt;
authenticating the user when the input matches the value at the particular spatial position of the grid.

11. The method of claim 10 wherein generating the grid further comprises:
(a) assigning a unique identifier to the user of the computing resource;
(b) concatenating the user identifier with an identifier for a given spatial position in the grid to form an input string;
(c) encrypting the input string to yield an output string of characters;
(d) selecting a subset of characters of the output string to serve as a value for the given spatial position of the grid; and
repeating steps (b)-(d) for each spatial position in the grid.

12. The method of claim 10 wherein distributing the grid further comprising sending the grid electronically to a computing device associated with the user.

13. The method of claim 12 further comprises sending the input from the user electronically from the computing device associated with the user to the authenticator.

14. The method of claim 10 distributing a physical embodiment of the grid to the user.

15. The method of claim 10 further comprises:
storing the unique identifier in a data store associated with the authenticator;
generating a controlling authentication factor for the user substantially contemporaneously with prompting the user for a value, where the controlling authentication factor is derived the value at the particular spatial position and the identifier stored in the data store; and
authenticating the user when the controlling authentication factor matches the input from the user.

16. A method for authenticating a user to access a computing resource, comprising:
distributing a software application from an authenticator to a computing device distinct from the authenticator and associated with the user, wherein the software application is configured with a unique identifier assigned to the user;
determining by the authenticator a value for generating an authentication factor using a random determination method;
prompting the user to input the value into the software application;
generating an authentication factor for the user based in part on the value input into the software application by the user; and
authenticating the user upon receipt of the authentication factor by the authenticator.

17. The method of claim 16 wherein determining a value further comprises randomly generating the value using a random number generator.

18. The method of claim 16 wherein prompting the user further comprises transmitting the value from the authenticator via a communication link to the software application residing on the computing device.

19. The method of claim 16 wherein generating an authentication factor further comprises:
concatenating the user identifier with the value input by the user into the software application to form an input string;
encrypting the input string to yield an output string of characters; and
selecting a subset of characters from the output string to serve as the authentication factor.

20. The method of claim 19 wherein the input string is encrypted using a one-way hash function.

21. The method of claim 16 wherein generating an authentication factor further comprises computing the authentication factor using a processor on the computing device and transmitting the authentication factor from the computing device via a communication link to the authenticator.

22. The method of claim 16 further comprises:
storing the unique identifier assigned to the user in a data store associated with the authenticator;
generating a controlling authentication factor for the user substantially contemporaneously with prompting the user, where the controlling authentication factor is derived from the value determining by the authenticator and the identifier stored in the data store; and
authenticating the user when the controlling authentication factor matches the authentication factor received by the authenticator.

23. The method of claim 16 further comprises granting the user access to the computing resource once the user is authenticated by the authenticator.
